(19) United States
(12) Patent Application Publication
(10) Pub. No.: US 2010/0177888 A1
(43) Pub. Date: Jul. 15, 2010

(54) WARERMARKING AND ENCRYPTION OF ENTROPY-CODED DATA USING ADDITIVE HUFFMAN TABLE

(75) Inventors: Aweke Negash Lemma, Eindhoven (NL); Mehmet Utku Celik, Eindhoven (NL); Minne Van Der Veen, Eindhoven (NL); Stefan Katzenbeisser, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/667,247

(22) PCT Filed: Jul. 1, 2008
(86) PCT No.: PCT/IB08/52641

§ 371 Date: Dec. 30, 2009

(30) Foreign Application Priority Data
Jul. 6, 2007 (EP) 07111908.5

(51) Int. Cl. H04L 9/28; H03M 7/00

(52) U.S. Cl. 380/28; 341/50

(57) ABSTRACT

A secure forensic watermarking system is disclosed that distributes the same encrypted content to all users. The decryption key is different for each user, so that the decrypted content differs slightly from the original, i.e. is watermarked. Forensic tracking is possible by distributing unique decryption keys to individual users. The invention allows a forensic mark to be securely embedded in the compressed domain signal. In an embodiment of this invention, the content (x) and an encryption sequence (r) are entropy encoded using a homomorphic Huffman table. A homomorphic Huffmann table is a table H having the property that there exists an operation f( ) such that H-1 (f(H(a),H(b)))=a+b.

### FIELD OF THE INVENTION

The present invention relates to methods and apparatus for processing signals, and more particularly but not exclusively to methods and apparatus for combining signals. The methods and apparatus have particular, although not exclusive, application in embedding watermarks in digital media signals.

### BACKGROUND OF THE INVENTION

Unauthorized distribution of digital media, such a music and movie files, is a serious problem and one of considerable concern to media owners. It is important to ensure that media distribution is properly controlled so as to ensure that a media owner's income stream is not adversely affected.

It has been proposed that watermark data should be embedded within digital media signals so as to mitigate the problem of unauthorized distribution. Such watermarks take a variety of forms. For example, playback-control watermarks may be used so as to restrict access to particular digital media signals to particular devices authorized to access those signals, and to prevent other devices from obtaining access to those signals.

Forensic watermarking is a technique which is intended to allow digital media signals which are distributed in an unauthorized manner to be traced to a particular authorized user. In this way, authorized users who initiate unauthorized distribution can be identified and appropriate action can be taken. Forensic watermarking is implemented in such a way that the embedded watermark is unique for each authorized user. In this way, all copies of the digital media signal can be traced back to the appropriate authorized user.

Many prior art techniques for combining two signals (such as a digital media signal and a watermark) operate on base-band data. The techniques cannot be readily applied to encrypted or encoded content. It is therefore often necessary to decrypt or decode signals prior to combination, and to subsequently encrypt or encode the resulting combined (watermarked) signal. Such an approach is computationally inefficient.

### OBJECT AND SUMMARY OF THE INVENTION

It is an object of embodiments of the present invention to obviate or mitigate at least some of the problems outlined above.

According to a first aspect of the present invention, there is provided a method and apparatus for processing a first entropy encoded signal representing first data and a second entropy encoded signal representing second data. The method comprises applying a first function to said first and second entropy encoded signals to generate a third entropy encoded signal representing third data. The third data represents a result of applying a second function to said first and second data.

In this way entropy encoded signals can be combined so as to generate a combined encoded signal which represents the combination of the data represented by each of the first and second entropy encoded signals. This is achieved without any requirement to decode input signals and subsequently encode a signal representing the combination of the decoded input signals. An efficient mechanism for combining signals is therefore provided. The first function is homomophic with respect to the second function. The second function may be an addition function. Each entropy encoded signal may be a compressed representation of the respective data.

The first signal may comprise a digital media signal, and the second signal may comprise a digital watermark. In such a case the first function allows an entropy encoded watermark to be embedded within an entropy encoded digital media signal without a requirement to decode the media signal and watermark before carrying out the embedding.

A plurality of entities may each be allocated unique watermarks, such that each entity can embed its own unique watermark in the digital media signal. In this way, digital media signals in which watermarks have been embedded can be processed to identify a particular entity. An entity can be a device or an individual.

The second entropy encoded signal may be configured such that the third entropy encoded signal represents an encrypted form of said first entropy encoded signal. For example, the second entropy encoded signal may comprise noise, such that the third signal comprises the first entropy encoded signal and said noise.

The first entropy encoded signal may comprise a digital media signal together with a first noise signal. The second signal may comprise a second noise signal such that said first function removes said noise from said first signal. For example, the second noise signal may be equal in magnitude but opposite in sign to the first noise signal. In such a case the first function is an addition function.

The entropy encoding may be based upon a coding scheme using variable length codewords. Such codewords may comprise a first portion indicating sign information and a second portion indicating magnitude information. The entropy encoding may be based upon a Huffman code, for example an exp-Golomb code.

The invention provides a computer program for carrying out the method described above, and such a computer program may be carried on a computer readable medium.

The invention further provides a computer apparatus for processing first and second signals. The apparatus comprises a memory storing processor readable instructions, and a processor configured to read and execute instructions stored in the program memory. The processor readable instructions comprise instructions controlling the processor to carry out the method described above.

### BRIEF DESCRIPTION OF DRAWINGS

Embodiments of the present invention will now be described, by way of example, with reference to the accompanying drawings, in which:

FIG. 1 is a schematic illustration of a process for entropy encoding of data;

FIG. 2 is a schematic illustration of a process for entropy decoding of data;

FIG. 3 is a schematic illustration of a prior art process for embedding data in entropy encoded data;

FIG. 4 is a schematic illustration of a process for embedding data in entropy encoded data in accordance with an embodiment of the invention;

FIG. 5 is an illustration of pseudo code suitable for implementing the embodiment of the invention shown in FIG. 4;

FIG. 6 is a flowchart showing operation of the pseudo code of FIG. 5; and

FIG. 7 is a schematic illustration of a scenario in which an embodiment of the invention can be employed.

### DESCRIPTION OF EMBODIMENTS

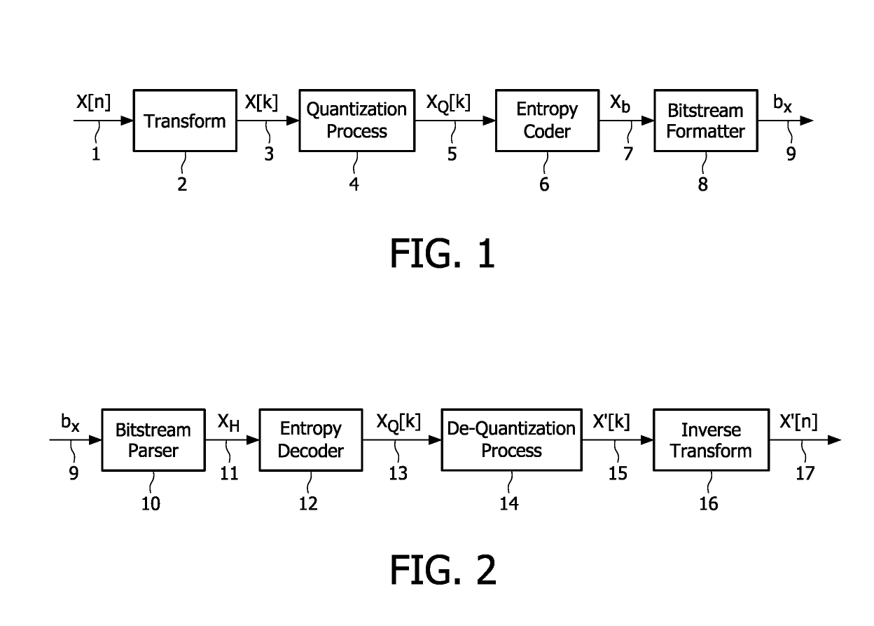

Referring to FIG. 1, a process for entropy encoding of data is shown. Such a process is often applied to digital media signals (e.g. signals representing sound and/or video data) which are to be distributed to consumers. Such distribution can be carried out using tangible carrier media (e.g. CDs and DVDs) or by way of a communications link.

A data stream 1 represents video and/or audio data and is input to an appropriate transform 2 which generates a transformed data stream 3. The transform can take any suitable form, although a discrete cosine transform (DCT) is used in some embodiments of the invention. The transformed data steam 3 is input to a quantization process 4 which outputs a quantized data stream 5. The quantization process typically provides compression such that the quantized data stream 5 requires ten to fifteen times less storage than the transformed data stream 3.

The quantized data stream 5 is entropy encoded by an entropy coder 6, so as to provide an entropy encoded data stream 7 which is then formatted by a bitstream formatter 8 to provide an output bitstream 9. The entropy coder 6 analyses the quantized data stream 5 and selects an encoding scheme which minimizes the storage requirements of the entropy encoded data stream 7. The entropy coder can conveniently employ a Huffman code. A Huffman code is a variable length code where values appearing frequently in the input data are represented by relatively short codewords, while values appearing infrequently are represented by longer codewords. Table 1 shows an example Huffman code.

TABLE 1

| Value | Codeword |
|---|---|
| 0 | 1 |
| 1 | 010 |
| −1 | 011 |
| 2 | 00100 |
| −2 | 00101 |
| 3 | 00110 |
| −3 | 00111 |
| 4 | 0001000 |
| −4 | 0001001 |
| 5 | 0001010 |
| −5 | 0001011 |
| 6 | 0001100 |
| −6 | 0001101 |
| 7 | 0001110 |
| −7 | 0001111 |
| . . . | . . . |

The Huffman code of Table 1 would be used where “0” is the most frequently occurring value in the quantized data stream 5, with “1” being the second most frequently occurring value, “−1” being the third most frequently occurring value, “2” being the fourth most frequently occurring value, “−2” being the fifth most frequently occurring value, and so on.

As an example, if the quantized data stream is as follows:

X_{Q}[k]={2, 0, 1, 0, −2, −1, 3, 0, 0, −1} (1)

Then the encoded data stream is:

x_{b}={00100, 1, 010, 1, 00101, 011, 00110, 1, 1, 011} (2)

It can therefore be seen that the output data comprises twenty-eight bits.

In general terms entropy encoding provides a compression gain which is such that the entropy encoded data stream 7 requires approximately half the storage space of the quantized data stream 5.

It will be appreciated that in order to access data which is encoded using the process of FIG. 1, a decoding process is required. FIG. 2 is a schematic illustration of such a decoding process. It can be seen that the bitstream 9 is input to a bitstream parser 10 which outputs an entropy encoded data stream 11. An entropy decoder 12 decodes the entropy encoded data stream 11 to generate a quantized data stream 13. The quantized data stream 13 is de-quantized by a de-quantization process 14 to generate a transformed data stream 15. The transformed data stream 15 is input to an inverse transform 16 which produces an output data stream 17 which can be appropriately processed.

If each of the stages of processing of FIG. 2 is an exact inverse of its corresponding stage in the processing of FIG. 1, the output data 17 will be identical to the input data 1. In practice, the processes shown in FIG. 1 (e.g. quantization) are such that providing an exact inverse is not readily possible. Accordingly, the output data 17 is an approximation of the input data 1.

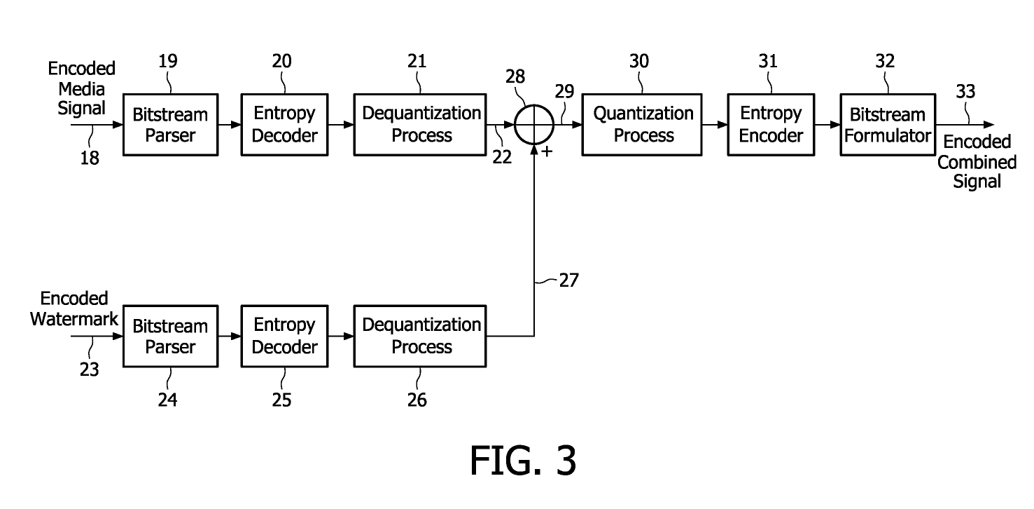

It is often desirable to combine data signals. For example, it is desirable to embed watermarks in digital media signals. FIG. 3 shows a known process for embedding a watermark in a digital media signal.

An encoded digital media signal 18 is parsed by a bitstream parser 19. Resulting data is input to an entropy decoder 20 which generates data for input to a dequantization process 21. The output of dequantization process 21 is transformed media data 22. That is, if the digital media signal was originally encoded using a process such as that shown in FIG. 1, the transformed media data 22 is an approximation of the data output from the transform 2.

An encoded watermark signal 23 is parsed by a bitstream parser 24. Resulting data is input to an entropy decoder 25 which generates data for input to a dequantisation process 26. The output of the dequantization process 26 is transformed watermark data 27. That is, if the watermark was originally encoded using a process such as that shown in FIG. 1, the transformed watermark data 27 is an approximation of the data output from the transform 2.

The transformed media data 22 and the transformed watermark data 27 are input to a combination process 28 which generates a combined signal 29. The combined signal 29 is input to a quantization process 30 which generates data for input to an entropy encoder 31, which in turn generates data for input to a bitstream formatter 32. The output of the bitstream formatter 32 is a combined encoded signal 33, representing the combination of the data represented by the encoded media signal 18 and the encoded watermark 23. It can be seen that to achieve combination of the encoded signals 18, 23 it is necessary to decode both the encoded media signal 18 and the encoded watermark 23 before combination, and to subsequently encode the combined signal. Such processing is relatively inefficient.

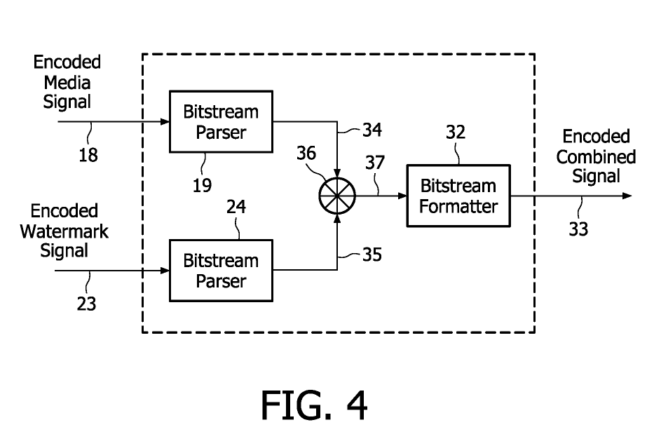

FIG. 4 shows a process for embedding a watermark in a digital media signal as provided by an embodiment of the invention.

Referring to FIG. 4, it can be seen that the encoded media signal 18 is input to the bitstream parser 19, as described above, the output from which is data 34. Similarly, the encoded watermark signal 23 is input to the bitstream parser 24, the output from which is watermark data 35. The data 34 and the watermark data 35 are input to a combination process 36 which generates a combined signal 37. The combined signal 37 is input to the bitstream formatter 32 to generate the encoded combined signal 33 as described above.

It can be seen that the process shown in FIG. 4 avoids the need to entropy decode and dequantize the input encoded media signal 18 and input encoded watermark 23. Consequently, the need quantize and entropy encode the combined signal is also avoided. It will therefore be appreciated that the process shown in FIG. 4 offers considerable efficiency benefits.

The combination process 36 is configured such that combination of the encoded media signal 18 and the encoded watermark signal 23 is carried out in such a way that the encoded combined signal 33 can be decoded to provide a signal indicative of the combination of the decoded encoded media signal 18 and the decoded encoded watermark signal 23. This is achieved by the combination process 36 being implemented as a homomorphic function ƒ, that is a function for which equation (3) is true:

H⁻¹(ƒ(H(a),H(b)))=a+b (3)

where:

a and b are decoded signals;

H is a function which takes a signal and generates an encoded signal;

ƒ is a function which combines encoded signals to generate a combined signal; and

H⁻¹ is a function which takes an encoded signal and decodes that signal.

It will be appreciated that in alternative embodiments of the invention the right hand side of equation (3) uses an operator other than the “+” operator.

Where entropy encoding is carried out using the Huffman code shown in Table 1, the function ƒ can be defined as described in further detail below.

First, it can be noted that the last bit of each codeword is indicative of the sign of the represented value. That is, where the represented value is positive the last bit of the codeword is ‘0’ while where the represented value is negative the last bit of the codeword is ‘1’. It can further be seen that the remaining bits of each codeword are indicative of the magnitude of the represented value. It should be noted that the codeword representing a value of ‘0’ is a special case.

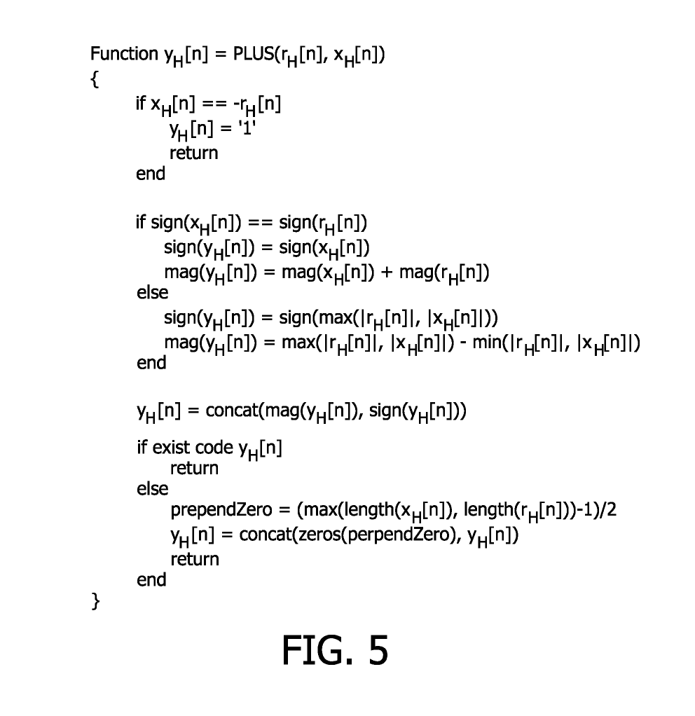

Values encoded using the Huffman code of Table 1 can be added by first determining the signs of the codewords to be added, and subsequently adding or subtracting the magnitudes of the codewords to be added, depending upon the processed signs. In this way an output codeword representing the encoded value of the addition of the values represented by the input codewords can be generated. Pseudo code implementing such processing is shown in FIG. 5 where a function PLUS is illuminated. One can verify that this PLUS function satisfies the property given in (3), that is:

H⁻¹(PLUS(H(a),H(b)))=a+b

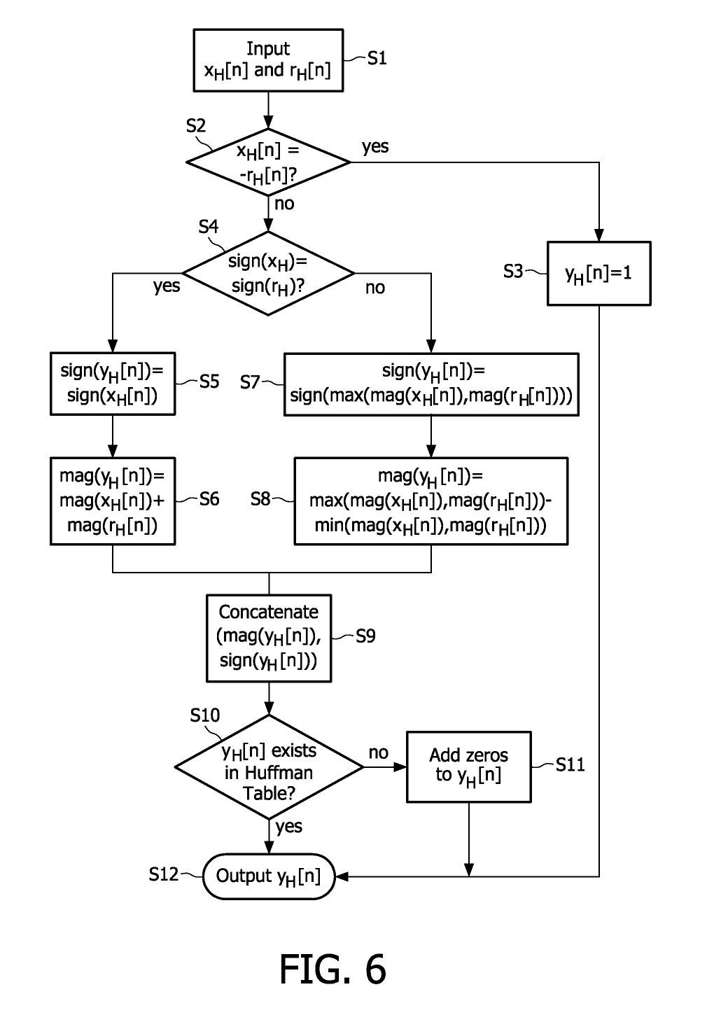

The PLUS function is described in further detail with reference to the flowchart of FIG. 6. The processing is configured to receive as input two input codewords x_{H}[n] and r_{H}[n] and to generate an output codeword y_{H}[n]. At step S1 the input codewords x_{H}[n] and r_{H}[n] are received as input. At step S2 a check is carried out to determine whether the input codewords have values which are equal and opposite. If the check of step S2 is satisfied, it can be determined that the output value is zero. Given that, as indicated above, the codeword representing the value zero is a special case, where the values of the two input codewords are equal and opposite, processing passes from step S2 to step S3 where the value of the output codeword y_{H}[n] is appropriately set.

If the check of step S2 is not satisfied, such that the input codewords do not have values which are equal and opposite, processing passes from step S2 to step S4. At step S4 a check is carried out to determine whether the two input codewords have the same sign. This processing is based upon a predefined “sign” function which takes a value and provides an output indicating its sign. If the two input codewords have the same sign, processing passes from step S4 to step S5. At step S5 the sign of the output codeword is set to be equal to the sign of the two input codewords. At step S6 the magnitude of the output codeword is set to be equal to the sum of the magnitudes of the two input codewords.

If the check of step S4 indicates that the two input codewords have differing signs, processing passes from step S4 to step S7 where the sign of the output codeword is set to be the sign of the input codeword having the largest magnitude. Here, it is to be noted that a predefined “mag” function is used which takes an input value and provides an output indicating its magnitude.

Processing passes from step S7 to step S8 where the magnitude of the output codeword is set by subtracting the magnitude of the input codeword having the smaller magnitude from the magnitude of the input codeword having the larger magnitude.

From the preceding description it will be appreciated that the processing of steps S5 and S6 and the processing of steps S7 and S8 both provide data indicating a sign and magnitude for the output codeword. Processing passes from each of steps S6 and S8 to step S9 where the output codeword is generated by concatenating the determined magnitude with the determined sign. Processing passes from step S9 to step S10 where a check is carried out to determine whether the codeword generated at step S9 is a recognized codeword. If this is not the case, zeros are prepended to the generated codeword at step S11 to generate an appropriate output codeword which is output at step S12. If the check of step S10 indicates that the codeword generated at step S9 is a recognised codeword, processing passes directly from step S10 to step S12. Processing similarly passes directly from step S3 to step S12.

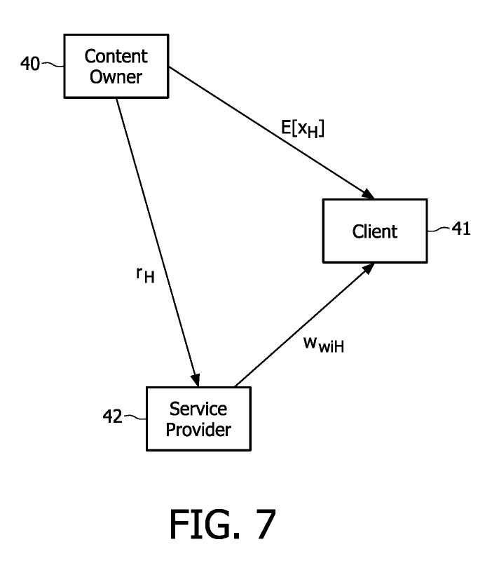

The preceding description has described the combination of encoded signals, and has explained how such combination can be used to embed a watermark signal in a digital media signal. An example of the use of the combination described above in a particular digital watermarking system is now described in further detail with reference to FIG. 7.

A content owner 40 wishes to securely distribute digital media content to a client 41 in such a way that the content cannot be accessed by an unauthorized third party, and in such a way that further distribution by the client 41 (which may be unauthorized) can be traced to the client 41.

The digital media content is encoded using a process as shown in FIG. 1 to generate encoded content x_{H}. The content owner 40 further generates a random sequence r and encodes the sequence using a process as shown in FIG. 1 to generate an encoded random sequence r_{H}. The sequence r is assumed to be distributed by way of a Gaussian distribution with zero mean.

The encoded content x_{H} and the encoded random sequence r_{H} are combined using the PLUS function described with reference to FIGS. 5 and 6. That is, two encoded data steams are combined so as to generate an encrypted bitstream.

E{x_{H}}=PLUS(x_{H}, r_{H}) (4)

The encrypted bitstream is provided by the content owner 40 to the client 41. To properly access the encoded content x_{H} it is necessary for the client 41 to remove the encoded random sequence from the encrypted bitstream.

The content owner 41 provides the encoded random sequence r_{H} to a service provider 42. The service provider 42 receives the encoded random sequence r_{H} and computes a decryption key for each recognised client i. The key r_{w}_{ᵢ}_{H} for a client i is given by equation (5):

r_{w}_{ᵢ}_{H}=PLUS(r_{H},−w_{iH}) (5)

Where W_{iH} is a watermark associated with client i.

The decryption key for each client is provided to the appropriate client 41 by the service provider 42, preferably by means of a secure communications link.

The decryption key for each client is formed such that subtraction of the key from the encrypted bitstream will remove the random sequence r while leaving a watermark wᵢ identifying the client i. That is, having obtained the encrypted bitstream E{x_{H}} and the appropriate decryption key r_{w}_{ᵢ}_{H} the client 41 will produce encoded content y_{H} according to equation (6):

y_{H}=PLUS(E{x_{H}},−r_{w}_{ᵢ}_{H}) (6)

Finally, the client 41 decodes y_{H} to obtain a watermarked signal y:

y=x+wᵢ (7)

Given that the watermark wᵢ is unique to a particular client i, the signal y can be determined to have originated from the client i. A method such as that described, where embedded watermarks identify particular clients, is referred to as a forensic watermarking method and is an effective way of tracing particular content to an original client to whom that content was originally provided.

It should be noted that the method described above with reference to FIG. 7 carries out a plurality of signal combination operations without requiring any decoding.

The method described with reference to FIG. 7 can be implemented in any convenient way, including over the Internet. It should be noted that the generation of decryption keys by the service provider 41 can be carried out as an offline process.

It will be appreciated that the embodiments described above are merely exemplary. Various modifications to the described embodiments will be readily apparent to the skilled person. In particular, although the embodiment of the invention described above implements a forensic watermarking technique, it will be appreciated that the described methods can be used with any suitable watermarking method. Furthermore, the methods described are not limited to embedding watermarks in digital media signals but are instead widely applicable to the processing of any two encoded signals.

A secure forensic watermarking system is disclosed that distributes the same encrypted content to all users. The decryption key is different for each user, so that the decrypted content differs slightly from the original, i.e. is watermarked. Forensic tracking is possible by distributing unique decryption keys to individual users. The invention allows a forensic mark to be securely embedded in the compressed domain signal. In an embodiment of this invention, the content (x) and an encryption sequence (r) are entropy encoded using a homomorphic Huffman table. A homomorphic Huffmann table is a table H having the property that there exists an operation ƒ( ) such that

H⁻¹(ƒ(H(a),H(b)))=a+b

1. A method of processing a first entropy encoded signal representing first data and a second entropy encoded signal representing second data, the method comprising:
applying a first function to said first and second entropy encoded signals to generate a third entropy encoded signal representing third data;
wherein said third data represents a result of applying a second function to said first and second data.

2. A method according to claim 1, second function is an addition function.

3. A method according to claim 1, wherein said first entropy encoded signal comprises a digital media signal.

4. A method according to claim 1, wherein said second entropy encoded signal comprises a digital watermark.

5. A method according to claim 4, wherein a plurality of entities are each allocated unique watermarks.

6. A method according to claim 1, wherein said second entropy encoded signal is configured such that the third entropy encoded signal represents an encrypted form of said first entropy encoded signal.

7. A method according to claim 6, wherein said second entropy encoded signal comprises noise.

8. A method according to claim 1, wherein said first entropy encoded signal comprises said digital media signal together with a first noise signal.

9. A method according claim 8, wherein said second entropy encoded signal comprises a second noise signal such that said first function removes said noise from said first entropy encoded signal.

10. A method according to claim 1, wherein said entropy encoding is based upon a coding scheme using variable length codewords.

11. A method according to claim 10, wherein said codewords comprise a first portion indicating sign information and a second portion indicating magnitude information.

12. A method according to claim 10, wherein said entropy encoding is based upon a Huffman code.

13. A computer program for carrying out a method according to claim 1.

14. A computer readable medium carrying a computer program according to claim 13.

15. A computer apparatus for processing first and second signals, the apparatus comprising:
a memory storing processor readable instructions; and
a processor configured to read and execute instructions stored in said program memory;
wherein the processor readable instructions comprise instructions controlling the processor to carry out a method according to claim 1.

16. Apparatus for processing a first entropy encoded signal representing first data and a second entropy encoded signal representing second data, the apparatus comprising:
means for applying a first function to said first and second entropy encoded signals to generate a third entropy encoded signal representing third data;
wherein said third data represents a result of applying a second function to said first and second data.
